(19) United States
(12) Patent Application Publication
(10) Pub. No.: US 2025/0289405 A1
(43) Pub. Date: Sep. 18, 2025

(54) METHOD FOR CONTROLLING A HYDRAULIC VOLUME

(71) Applicant: Robert Bosch GmbH, Stuttgart (DE)

(72) Inventor: Reid Collins, Forchtenberg (DE)

(21) Appl. No.: 18/860,731

(22) PCT Filed: Jul. 31, 2023
(86) PCT No.: PCT/EP2023/071163

§ 371 Date: Oct. 28, 2024

(30) Foreign Application Priority Data
Sep. 28, 2022 (DE) 10 2022 210 243.6

(51) Int. Cl. B60T 13/68; B60T 13/16; B60T 13/74

(52) U.S. Cl. CPC B60T 13/686; B60T 13/161; B60T 13/745

(57) ABSTRACT

A method for controlling a hydraulic volume in a system including a power brake hydraulically connected to a driving dynamics control. The method includes generating a control signal using the driving dynamics control and providing a control signal for the power brake, for providing hydraulic volumes for the driving dynamics control. The method further includes performing a control of the driving dynamics, returning the hydraulic volume from the driving dynamics control, after the control of the driving dynamics has ended, to a reservoir via previously opened circuit isolating valves, via which the driving dynamics control is connectable to the reservoir. The method also includes closing the circuit isolating valves and controlling the brake pressure in the driving dynamics control using a power piston arranged in a power cylinder, in the event that an active braking maneuver is initiated before or while returning the hydraulic volume.

### FIELD

The present invention relates to a method for controlling a hydraulic volume in a system composed of a power brake and a driving dynamics control. In addition, the present invention relates to a system for controlling a hydraulic volume.

### BACKGROUND INFORMATION

In addition to stabilizing functions, for example in the form of a traditional ESP/ABS function, current vehicle brake systems increasingly contain expanded functions, such as support of the driver, or application of force to the brake pedal during the brake actuation by an eBKV (electromechanical brake booster) or also assisted or partially assisted functions by means of a unit for active modulation of the hydraulic brake pressure (e.g., ESP, eBKV, boost unit, etc.), without active involvement of the driver.

Driver assistance systems are becoming more and more widespread in today's motor vehicles in various forms. They intervene in a partially automated or automated manner in the drive, control (e.g., steering) or signaling devices of the vehicle or warn the driver by means of suitable human-machine interfaces shortly before or during critical situations. A brake system typically comprises an electronic brake booster (EBB) and an ESP system. In this combination, the majority of the brake system functions can be realized by means of an ESP system and the brake booster is used as an external controller to build up dynamic pressure.

In this case, brake systems can operate with a closed hydraulic system, i.e., a reservoir with hydraulic fluid of the brake system is only used for leakage and temperature compensation and an available hydraulic volume is thus constant. Examples in this respect are traditional brake systems, such as vacuum brake boosters, electromechanical brake boosters, such as the iBooster, or also a decoupled power brake (DPB) combined with an ESP system. Alternatively, brake systems can operate with an open hydraulic system, such as IPB (integrated power brake) systems. In this case, a reservoir with hydraulic fluid can be used in normal operation to temporarily store hydraulic volumes. The utilized hydraulic volume of the brake system can thus change during braking. Respective brake systems have different disadvantages; for example, systems with a closed hydraulic system have the problem that, depending on the operation, a suction of an ESP system should have more hydraulic volume in the relevant region of the brake system, i.e., below the master brake cylinder up to the brake cylinders on the wheels, than should be present in normal operation.

### SUMMARY

An object of the present invention is to provide a method for controlling a hydraulic volume in a system composed of a power brake and a driving dynamics control, in which no pressure remains in the brake system when the brake is released, despite a power cylinder without any compensation connections.

The object may be achieved by a method for controlling a hydraulic volume with certain features of the present invention. Furthermore, the present invention provides a system. Advantageous example embodiments and developments of the present invention are disclosed herein.

The present invention provides a method for controlling a hydraulic volume in a system composed of a power brake and a driving dynamics control, wherein the power brake is hydraulically coupled to the driving dynamics control. The method comprises the steps of generating a control signal by means of the driving dynamics control and providing a control signal for the power brake, for providing hydraulic volume for the driving dynamics control, and performing a control of the driving dynamics. A further step comprises returning the hydraulic volume from the driving dynamics control, after the control of the driving dynamics has ended, to a reservoir via previously opened circuit isolating valves, via which the driving dynamics control is connectable to the reservoir.

In the event that an active braking maneuver is initiated before or while returning the hydraulic volume, the circuit isolating valves are closed and the brake pressure in the driving dynamics control is controlled by means of a power piston arranged in a power cylinder.

After closing the circuit isolating valves, the hydraulic volume cannot be discharged due to the power cylinder not having any compensation connections. In contrast to the related art, the power cylinder does not additionally introduce hydraulic volume, but rather the brake pressure in the driving dynamics control is controlled via the power piston. For controlling, the power piston is moved forward or backward so that hydraulic volume can correspondingly be introduced into the driving dynamics control or withdrawn therefrom. For releasing the brakes, the hydraulic volume in the driving dynamics control is accordingly reduced by moving the power piston backward. As a result, the brakes can be released despite the power cylinder not having any compensation connections and the circuit isolating valves being closed. Accordingly, no lines are necessary between a compensation connector and the reservoir so that material and thus costs are saved. Additionally, the installation space for such a system can be reduced.

In a preferred example embodiment of the present invention, the circuit isolating valves are opened after the control of the driving dynamics has ended. The circuit isolating valves are thus opened only after the control of the driving dynamics has ended and, if no active braking maneuver is initiated, in order to be able to return the hydraulic volume to the reservoir. During the control of the driving dynamics, the circuit isolating valves are thus closed. If an active braking maneuver needs to be performed during the control of the driving dynamics, these valves do not need to be closed first, so that the time for braking is reduced. Additionally, even before performing the active braking maneuver, it can be determined that a valve fails to close in the event of a failure, so that an early response to this failure is possible. This additionally increases safety.

In a further preferred example embodiment of the present invention, the circuit isolating valves are opened before the control of the driving dynamics is performed. The circuit isolating valves are thus already open during the control of the driving dynamics. This allows the hydraulic volume to be quickly discharged into the reservoir after the control of the driving dynamics.

According to an example embodiment of the present invention, preferably, the power piston is displaced forward by a travel distance before performing the control of the driving dynamics.

The driving dynamics control is thus additionally fed hydraulic volume from the power cylinder. This allows the driving dynamics to be quickly supplied with the necessary hydraulic volume. It is additionally ensured that sufficient hydraulic volume can again be received in the power cylinder from the driving dynamics control in order to be able to reduce the pressure there, if necessary, to release the brakes.

In an advantageous development, the power piston is displaced backward by a travel distance after returning the hydraulic volume. Advantageously, the power piston is displaced to a rear end position. By displacing the piston backward, the hydraulic brake volume in the power cylinder is increased. After performing the method, sufficient brake volume is thus available to be able to perform safe active braking.

Advantageously, according to an example embodiment of the present invention, the hydraulic volume is controlled with a power cylinder without any compensation connections. A power cylinder without any compensation connections is distinguished by its lack of compensation connections, via which the driving dynamics control is connected to the reservoir for the purpose of returning hydraulic volume, even when the circuit isolating valves are closed.

In a further advantageous example embodiment of the present invention, the driving dynamics control together with the control signal communicates information about the required hydraulic volume. Advantageously, the travel distance is adjusted to a front position of the power piston according to the required hydraulic volume. By means of this information, it is possible to better control the pressure in the driving dynamics control. Accordingly, it is possible to control the power piston to ensure that this volume can be received again by the power cylinder after active braking. As a result, the brake can be released again.

The object underlying the present invention is additionally achieved by a system for controlling a hydraulic volume in a system composed of a power brake and a driving dynamics control. According to an example embodiment of the present invention, the system comprises a power brake, a driving dynamics control hydraulically coupled to the power brake, a control unit for controlling the driving dynamics control, wherein the power brake is coupled in terms of signals to the driving dynamics control, and wherein the system is configured to perform the method according to the present invention. Such a device substantially has the advantages mentioned with respect to the method.

According to a further suitable embodiment of the present invention, the power brake comprises a power cylinder, which does not have any compensation connections. By means of such a power brake, the advantages described above are achieved.

Exemplary embodiments of the present invention are shown in the figures and explained in more detail in the following description.

### BRIEF DESCRIPTION OF THE DRAWINGS

FIG. 1 shows a system composed of a power brake and a driving dynamics control, during the control of the driving dynamics.

FIG. 2 shows an exemplary embodiment of a method of the present invention for controlling a hydraulic volume in a system composed of a power brake and a driving dynamics control.

### DETAILED DESCRIPTION OF EXAMPLE EMBODIMENTS

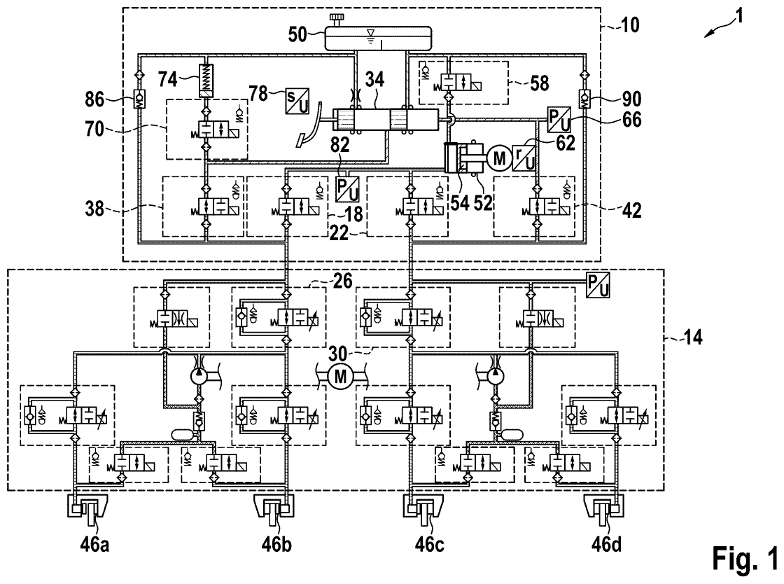

In FIG. 1, a system 1 composed of a power brake 10 and a driving dynamics control 14 is shown during the control of the driving dynamics. The system 1 is configured to couple the power brake 10 hydraulically to the driving dynamics control 14 by means of a first and second coupling valve of the power brake 18 and 22 and a first and second coupling valve of the driving dynamics control 26 and 30 and thus to form a hydraulic coupling. In this case, both the power brake 10 and the driving dynamics control 14 have two circuits.

A master cylinder 34 can be actuated manually by means of a pedal that is mechanically connected to the master cylinder 34, in order to act hydraulically by means of a first or a second circuit isolating valve 38 or 42 by means of respectively assigned circuits of the driving dynamics control 14 on brake cylinders 46a, 46b, 46c and 46d in order to achieve an emergency braking action. The master brake cylinder 34 is hydraulically connected to a reservoir 50 for hydraulic fluid.

During normal operation, the braking action on the brake cylinders 46a, 46b, 46c and 46d can be brought about by means of a power cylinder 52 in that a power piston 54 in the power cylinder 52 displaces hydraulic volume via the coupling valves of the power brake 18, 22 into the two circuits of the driving dynamics control 14. The power cylinder 52 may be hydraulically coupled to the hydraulic reservoir 50 via a power cylinder valve 58. The power cylinder 52 is coupled to an electric motor in order to be able to deliver or receive hydraulic volume by means of the power piston 54. The electric motor can be controlled by a controller that is coupled to a sensor system for determining the electric motor position 62. The pressure of the master cylinder 34 can be determined by means of a pressure sensor 66.

The two-circuit master cylinder 34 can be hydraulically coupled via a brake simulator valve 70 to a brake simulator 74 in order to simulate a hydraulic pressure build-up for a driver who actuates the brake pedal. During normal operation, the hydraulic volume for the driving dynamics control 14 is in this case provided by the power piston 54 in order to achieve a braking action on the brake cylinders 46a, 46b, 46c, 46d, which are hydraulically coupled to the driving dynamics control 14. A mechanical position of the brake pedal can be determined by a pedal displacement transducer 78, which is mechanically coupled to the brake pedal, in order to control the power piston 54.

The pressure generated by the power piston 54 will be determined by means of a power piston pressure sensor 82. By means of a first and second check valve 86, 90, additional hydraulic fluid from the reservoir 50 can be delivered to the hydraulic system composed of the power brake 10 and the driving dynamics control 14. The driving dynamics control 14 is constructed in a conventional manner so that a detailed description thereof is omitted.

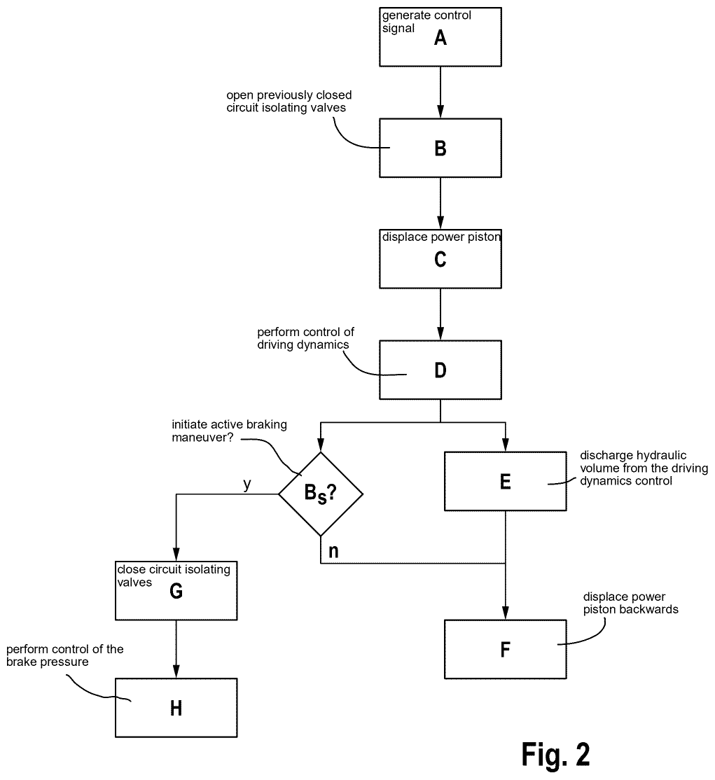

FIG. 2 shows an exemplary embodiment of a method for controlling a hydraulic volume in a system 1 shown in FIG. 1. In a first step A of the method, a control signal is generated in a control unit of the driving dynamics control 14. This control signal is provided for the power brake 10 so that hydraulic volume can be provided for the driving dynamics control 14. In a second step B, the previously closed circuit isolating valves 38, 42 are opened. As a result, the driving dynamics control 14 can obtain additional hydraulic fluid from the reservoir 50 via check valves 86, 90. In a next step C, the power piston 54 is displaced forward toward an outlet to the driving dynamics control 14. As a result, additional hydraulic fluid is provided to the driving dynamics control 14 by the power cylinder 52.

In a subsequent step D, a control of the driving dynamics is performed in a conventional manner. After the control of the driving dynamics, in a next step E, the hydraulic volume is discharged from the driving dynamics control 14 via the opened circuit isolating valves 38, 42 through the master cylinder 34 into the reservoir 50. At the start of the returning process, it is monitored whether an active braking maneuver is initiated via the pedal. If this Is not the case, after returning the hydraulic volume, the power piston 54 is again displaced backward in a subsequent step F so that sufficient hydraulic fluid for an active braking maneuver is available in the hydraulic cylinder 34. As a result, brake fluid is displaced into the power cylinder 52, either via the power cylinder valve 58 or via the hydraulic path of the master cylinder 34, the circuit isolating valves 38, 42, and the coupling valves of the power brake 18, 22.

In the event that an active braking maneuver Bs is to be initiated before or during the step of returning E the hydraulic volume, the circuit isolating valves 38, 42 are closed in a next step G. Subsequently, a control of the brake pressure in the driving dynamics control is performed by means of the power piston 54 in a next step H. After the active braking maneuver has ended, the power piston 54 is displaced backward so that the hydraulic volume of the driving dynamics control 14 is received in the power cylinder 52. As a result, after the active braking maneuver has ended, the brake cylinders 46a, 46b, 46c, 46d can be released without brake pressure remaining in the driving dynamics control 14.

1-10. (canceled)

11. A method for controlling a hydraulic volume in a system including a power brake and a driving dynamics control, wherein the power brake is hydraulically coupled to the driving dynamics control, the method comprising the following steps:
generating a control signal using the driving dynamics control and providing a control signal for the power brake, for providing hydraulic volume to the driving dynamics control;
performing a control of the driving dynamics;
returning the hydraulic volume from the driving dynamics control, after the control of the driving dynamics has ended, to a reservoir via previously opened circuit isolating valves, via which the driving dynamics control is connectable to the reservoir; and
closing the circuit isolating valves and controlling the brake pressure in the driving dynamics control using a power piston arranged in a power cylinder, when an active braking maneuver is initiated before or while returning the hydraulic volume.

12. The method according to claim 11, wherein the circuit isolating valves are opened after the control of the driving dynamics has ended.

13. The method according to claim 11, wherein the circuit isolating valves are opened before performing the control of the driving dynamics.

14. The method according to claim 11, wherein the power piston is displaced forward by a travel distance before performing the control of the driving dynamics.

15. The method according to claim 11, wherein the power piston is displaced backward by a travel distance after returning the hydraulic volume.

16. The method according to claim 11, wherein the hydraulic volume is controlled using a power cylinder without any compensation connections.

17. The method according to claim 11, wherein the driving dynamics control together with the control signal communicates information about a required hydraulic volume.

18. The method according to claim 11, wherein the travel distance is adjusted to a front position of the power piston according to a required hydraulic volume.

19. A system for controlling a hydraulic volume in a system including a power brake and a driving dynamics control, the system comprising:
a power brake;
a driving dynamics control hydraulically coupled to the power brake; and
a control unit configured to control the driving dynamics control, wherein the power brake is coupled in terms of signals to the driving dynamics control; and
wherein the system is configured to:
generate a control signal using the driving dynamics control and providing a control signal for the power brake, for providing hydraulic volume to the driving dynamics control;
perform a control of the driving dynamics;
return the hydraulic volume from the driving dynamics control, after the control of the driving dynamics has ended, to a reservoir via previously opened circuit isolating valves, via which the driving dynamics control is connectable to the reservoir; and
close the circuit isolating valves and controlling the brake pressure in the driving dynamics control using a power piston arranged in a power cylinder, when an active braking maneuver is initiated before or while returning the hydraulic volume.

20. The system according to claim 19, wherein the power brake includes a power cylinder which does not have any compensation connections.
